(19) United States
(12) Patent Application Publication
(10) Pub. No.: US 2008/0235062 A1
(43) Pub. Date: Sep. 25, 2008

(54) METHOD AND SYSTEM FOR INITIALLY PROJECTING AN INSURANCE COMPANY'S NET LOSS FROM A MAJOR LOSS EVENT

(75) Inventors: Richard Lasota, New York, NY (US); Paul Cahill, Clark, NJ (US); Paul Di Paola, New York, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/966,813

(22) Filed: Dec. 28, 2007

Related U.S. Application Data
(60) Provisional application No. 60/882,802, filed on Dec. 29, 2006.

(51) Int. Cl. G06Q 40/00

(52) U.S. Cl. 705/4

(57) ABSTRACT

A system and method by which an insurance company can project an initial net projected loss arising from a major loss event quickly after the occurrence of the event. The system uses a networked central repository, such as an electronic collaboration site, for collecting and sharing information to be used in the initial net loss projection process. After the occurrence of a major incident, media reports can be reviewed to identify entities involved in, or affected by, the event. In-force insurance policies and applicable reinsurance information of the identified entities are collected and stored in the repository and reviewed to identify those that should be included in the initial net loss projection. Additional information can be entered into a policy database regarding those policies which allows aggregation of net policy limits and an initial projection of the net loss arising from the major loss event.

### CROSS-REFERENCE TO RELATED APPLICATIONS

This patent application claims the benefit of priority to U.S. Provisional Patent Application No. 60/882,802, filed on Dec. 29, 2006, and entitled “Method and System for Initially Projecting an Insurance Company's Net Loss Resulting From a Major Loss Event,” which is incorporated in its entirety herein by this reference.

### FIELD OF THE INVENTION

This invention generally relates to a method and system for projecting the initial net loss resulting from a major loss event, and more particularly to a method and system for generating an initial projection of the net loss of an insurance company from a major loss event.

### BACKGROUND OF THE INVENTION

From time to time, a major incident may occur that causes significant losses of human life and/or property damage. Such an incident is hereinafter referred to as a “major loss event” or “MLE.” The damages caused by an MLE may be related to loss of lives, physical injuries, destruction of properties, product defects, etc. A major loss event typically draws immediate media attention, but the behind-the-scene filing of insurance claims and the investigation and adjustment of those claims by an insurance company normally goes unnoticed by the public. Business operations and properties are often covered by insurance policies, and a major loss event can trigger the filing of various insurance claims for property damages and bodily injury damages, including the loss of lives, for example.

The aggregated insurance policy limits on policies for which claims might be filed in connection with a major loss event constitute potential financial exposure for the insurance company and can be very high, such as on the order of tens of millions of dollars or even higher. As a result, when an MLE occurs, it would be advantageous for the high-level executives of an insurance company, such as the Chief Claims Officer, to know promptly the initial net loss exposure (if any) that the major loss event presents to the company. It would be desirable to have an initial net loss projection shortly after the occurrence of the incident, such as within twenty-four to seventy-two hours, even without the benefit of a complete investigation regarding the event and resulting liability and damages issues. Unfortunately, within the conventional business structure of an insurance company, generating a relatively accurate net loss projection in a very short period of time has been a very difficult task.

A major loss event may involve multiple entities that are identified by the news media as being involved in, or impacted by, an MLE. There may or may not be insurance policies issued to these entities, and some of the insurance policies may or may not be relevant to the particular incident. Typically, right after the occurrence of a major loss event, an insurance company has limited knowledge of the identities of all the entities that are involved, or whether there are in-force insurance policies covering such entities that might be relevant to the initial loss projection for that MLE. The identities of the entities and the existence of relevant in-force policies are sometimes ascertained only when insurance claims relating to the loss event are received by the insurance company, which can be many days, or even months, after the incident.

The task of producing an initial net loss projection in an efficient manner can be made more difficult in cases where the potentially relevant insurance policies have been issued by different underwriting divisions of the insurance company. Furthermore, it can sometimes be difficult to effectively coordinate the personnel at the different corporate branches to work on the initial net loss projection before actual claims have been submitted. Additionally, a policy affording coverage for an MLE may have been issued to an affiliate of an entity identified in the media, or, in some cases, to an unrelated entity.

The possible existence of reinsurance treaties or facultative certificates that would reduce the policy limit exposure presented by some of the relevant insurance policies further complicates the initial net loss projection process. Delays in accounting for these possible offsets in exposure further reduce the accuracy of any initial estimate of net loss caused by an MLE.

The foregoing complexities can make it difficult to provide an accurate initial net loss projection, especially when information regarding the relevant insurance policies and applicable reinsurance may not be quickly and efficiently gathered within the conventional corporate structure of the insurance company.

### SUMMARY OF THE INVENTION

In view of the foregoing, it is an object of the invention to provide a framework for making an initial projection of the net loss associated with a major loss event that enables collaboration between different branches of a corporation and is capable of providing a comprehensive and reliable assessment of the initial net loss projection quickly after the occurrence of a major incident.

It is a related object of the invention to provide such a framework for making projections of the initial net loss for major loss events that enables effective collaboration, information collection, exchange, and archiving to facilitate accurate analysis and decision making during the initial net loss projection process as well as effective review and communication of the results after the process is completed.

These objects and other related objects are achieved by the present invention, which provides a novel method and system for generating an initial net loss estimate for a major loss event. In accordance with an embodiment of the invention, a central repository of event-related information and insurance data is provided on a network and selected persons in the insurance company are assigned respective responsibilities to perform tasks to collect and analyze the information and insurance data from a plurality of sources to generate an initial estimate of the net loss.

Once an incident with significant loss implications has occurred, it is identified as a major loss event, and an initial alert message can be composed and sent to persons involved in the loss projection process. An event file for the particular MLE under scrutiny can be created in an electronic collaboration site (ECS). The event file can include folders for storing various categories of documents, including alerts, media coverage, and policy information. Facts regarding the incident, which can, for example, be obtained from media coverage of the incident, can be gathered and analyzed to identify entities that were involved in, or impacted by, the MLE. Electronic copies of relevant media coverage can be placed in a Media Research folder. All in-force insurance policies issued to the identified entities by the company can be identified. Electronic copies of relevant policy and reinsurance documents can be placed in an In-Force Policies folder in the MLE event file by any member of the MLE group. Each identified policy can be reviewed by the MLE group members to determine whether it is relevant to the incident such that it should be included in the initial loss projection. The net limits of the identified relevant policies can be aggregated in an In-Force Policies database in the event file to generate a projection of the initial net loss associated with the incident.

### BRIEF DESCRIPTION OF THE DRAWINGS

The advantages of the invention (which creates a unique method to encourage effective collaboration amongst different business areas of the insurance company) can be understood from the description of embodiments of the invention set forth below with reference to the drawings, in which:

FIG. 1 is a schematic diagram showing a networked computer system in accordance with an embodiment of the invention for collecting and sharing information for developing a comprehensive initial projection of net losses associated with a major loss event;

FIG. 2 is a flowchart showing an embodiment of a process using the system of FIG. 1 to provide an initial projection of net loss resulting from an MLE according to the present invention;

FIG. 3 is a specimen of an MLE Initial Alert suitable for use with the present invention;

FIGS. 4A-4B is a specimen of an MLE Policy alert suitable for use with the present invention;

FIG. 5 is a specimen of an MLE Updated Policy alert suitable for use with the present invention;

FIGS. 6A-6B is a second specimen of an MLE Updated Policy alert suitable for use with the present invention;

FIG. 7 is a flow chart showing another embodiment of a process for generating an initial projection of net loss resulting from an MLE according to the present invention.

FIG. 8 is a specimen of an MLE Termination alert suitable for use with the present invention;

FIG. 9 is an MLE home web page presented by an initial net loss projection server in the networked system of FIG. 1;

FIG. 10 is a webpage presented by the initial net loss projection server in the networked system of FIG. 1 for showing an event file for an MLE;

FIG. 11 is a webpage presented by the initial net loss projection server for showing an Alerts folder in the event file of FIG. 10;

FIG. 12 is a webpage presented by the initial net loss projection server for showing a Media Research folder in the event file of FIG. 10;

FIG. 13 is a webpage presented by the initial net loss projection server for showing an In-Force Policies folder of the event file of FIG. 10;

FIG. 14 is a webpage presented by the initial net loss projection server for showing an In-Force Policy database of the event file of FIG. 10;

FIG. 15 is a webpage as in FIG. 14, but illustrating a graphical user interface that allows information in the In-Force Policy database to be sorted by a selected category;

FIG. 16 is another embodiment of a webpage presented by the initial net loss projection server in the networked system of FIG. 1 for showing another embodiment of an event file for an MLE in the form of a template to facilitate the creation of a plurality of event files using a similar format;

FIG. 17 is a webpage presented by the initial net loss projection server for showing an Alerts folder in the event file of FIG. 16;

FIG. 18 is a webpage presented by the initial net loss projection server for showing a Media Research folder in the event file of FIG. 16;

FIG. 19 is a webpage presented by the initial net loss projection server for showing an In-Force Policies folder of the event file of FIG. 16;

FIG. 20 is a webpage presented by the initial net loss projection server for showing an In-Force Policy database of the event file of FIG. 16;

FIG. 21 is a webpage presented by the initial net loss projection server for showing a Policy Record Help page in connection with the In-Force Policy database of FIG. 20; and

FIG. 22 is a webpage presented by the initial net loss projection server that contains an embodiment of a dashboard summary including charts summarizing the initial net loss projection for an MLE.

### DETAILED DESCRIPTION OF EMBODIMENTS OF THE INVENTION

The present invention is directed to a new approach to generating an initial projection of net losses associated with an MLE. As described below, the invention enables the collaborative, prompt generation of an initial net loss projection within a short time frame, such as, within twenty-four to seventy-two hours after the MLE, for example.

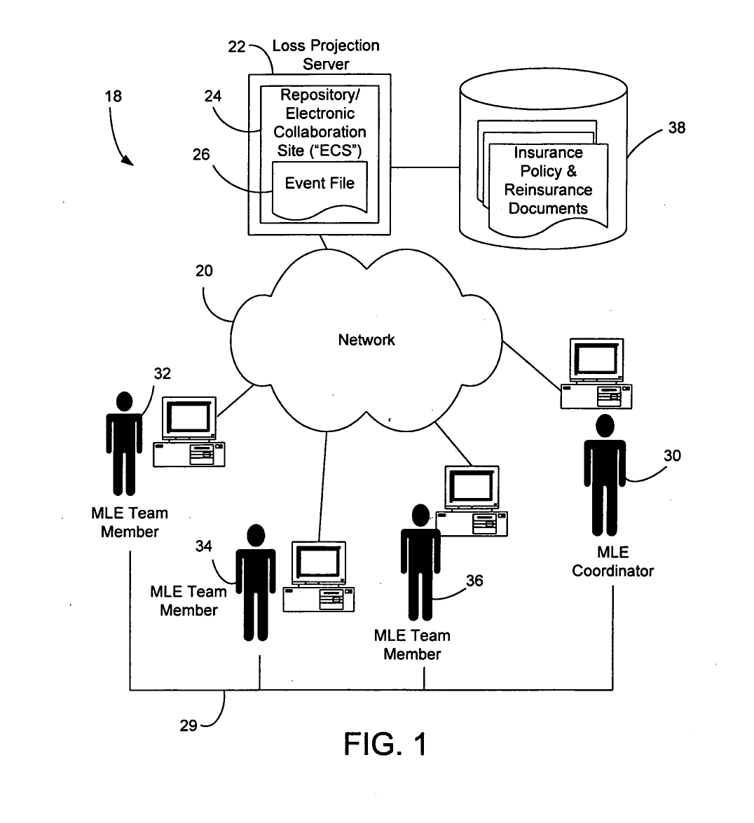

Turning now to FIG. 1, in accordance with an aspect of the invention, a system 18 for initially projecting an insurance company's net loss caused by an MLE can include a computer network 20 on which a server 22 resides. The server 22, hereinafter referred to as the “initial net loss projection server,” can include a program running thereon that provides the functionality of an information repository 24 that can be accessed by users over the network 20 for storing, editing, and analyzing information and storing decision results for producing the initial net loss projection. As illustrated in FIG. 1, there can be a team 29 of users 30, 32, 34, 36 that can access the information repository 24 provided by the server 22 over the network 20.

In some embodiments, the network 20 can be, for example, an intranet of an insurance company or, in other embodiments, a public network such as the Internet. Preferably, in embodiments of the invention where the network 20 comprises the Internet, the network 20 further includes suitable security measures to prevent unauthorized access to the information repository 24 and/or eavesdropping.

The information repository 24 can be accessed over the network 20 by users that participate in the initial net loss projection process to collaboratively collect and share information and results of accurate analysis. The information repository can include a database containing the contact information for each individual in the MLE group. The information repository 24 can include an event file 26 for housing the information collected concerning a particular MLE. The information repository 24 can include a plurality of event files 26, with each corresponding to a particular MLE. The information repository 24 can include a database containing summary information about each MLE for which an event file is found in the information repository 24. The MLE List database can include information such as, the date when and the place where the MLE occurred; a short narrative of the MLE; a short description of the damage caused by the MLE; and the status of the MLE.

Each event file can include a plurality of folders for storing particular categories of information, such as respective folders for alerts, media research, and policy and reinsurance documents. Each event file can include one or more databases for storing information used to calculate the initial net loss projection based on the information collected in the event file 26.

A database 38 of insurance policy and reinsurance information can be accessed by the initial net loss projection team 29 over the network 20. The database 38 can be searched to determine whether the insurance company has issued a policy to any of the entities identified as being involved in, or affected by, the MLE. Results of such searches can be stored in the event file 26. Copies of the identified insurance policies and reinsurance documents can also be placed in the event file, such as, by providing a hyperlink to an electronic version of the particular policy or reinsurance document.

In one embodiment, the team 29 of users participating in a particular initial net loss projection process comprises a plurality of team members 30, 32, 34, 36, with one being the team coordinator 30. The individuals comprising the initial net loss projection team 29 can be predetermined, standing ready for an MLE to occur, or can be established from a pool of individuals in the MLE group for that particular MLE upon its occurrence, for example.

The coordinator or senior claims management 30 can assign each team member 32, 32, 36 at least one role and/or responsibility. The coordinator 30 can assign the roles and responsibilities such that duplication of efforts while performing the tasks for determining the initial net loss projection is substantially avoided. The coordinator 30 can have a higher level of authorized access to the information repository 24 than the other members of the initial loss projection team 29. For example, the coordinator 30 can have the ability to create an event file 26 for a new MLE, whereas other members of the team 29 do not.

The team members 30, 32, 34, 36 can belong to different divisions or branches of the insurance company that implements the initial net loss projection system 18. For instance, the insurance company may include various divisions such as Claims, Underwriting, and Reinsurance. Each division can designate one or more persons to be included among the members of the initial net loss projection team 29. The collective knowledge of the individuals comprising the initial net loss projection team 29 and the delegation of specific roles and responsibilities to individuals of the team 29 allow for effective collaboration amongst these different business areas in the MLE process.

In one embodiment, the information repository 24 is implemented as an electronic collaboration site (“ECS”). An ECS provides a rapidly deployed and easily adopted Web-based collaborative workspace that enables individuals of the initial net loss projection team 29 that are located in different locations and/or divisions to work together more efficiently. As described in greater detail below, the ECS facilitates the collection and storage of insurance information regarding a major loss event, and enables access to the information by the initial net loss projection team 29 to collaboratively generate an initial net loss projection. An example of an ECS 24 suitable for use with the present invention is commercially-available from EMC Corporation of Hopkinton, Mass., under the trade name Documentum eRoom. Yet another example of an ECS suitable for use with the present invention is commercially-available from Microsoft Corporation of Redmond, Wash., under the tradename SharePoint.

The ECS 24 can be used to issue an alert to all individuals in an initial net loss projection team that an MLE has occurred. Additional alerts can be issued to the team via the ECS at various stages of the initial net loss projection process, for example, when an entity identified as being involved in the MLE is found to have an in-force insurance policy issued by the company. The ECS 24 can include a notification feature that issues a notification, via an email message, for example, to quickly inform the individuals in the team that new information has been added to an active event file 26. For example, when a document has been added to any part of the event file 26, the ECS 24 can automatically notify each individual of the loss projection team 29 that an update has been made. In some embodiments, each team member can select the level of notification that he/she wishes to receive, for example, instantaneously upon any change, once a day listing all of the day's changes, or not at all.

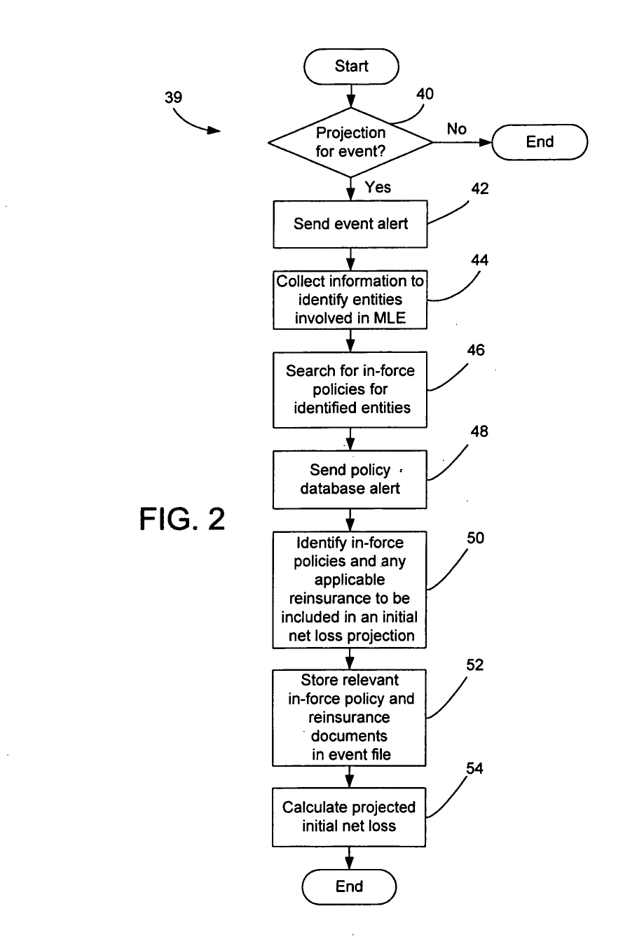

Referring to FIG. 2, an embodiment of a method 39 for generating an initial net loss projection resulting from an MLE according to the present invention is shown. The method 39 can be performed using the system 18 shown in FIG. 1. When an event with significant loss implications has occurred, any member of the initial net loss projection team can make an initial determination of whether the loss event is significant enough to warrant the initiation of the MLE initial net loss projection process (step 40). Any member of the MLE group can initiate an initial loss projection process by sending an MLE Initial alert. If the loss event is deemed significant enough to require an initial loss projection, an MLE Initial alert can be sent from the MLE ECS (e.g., by email) to all the members of the initial net loss projection team (step 42).

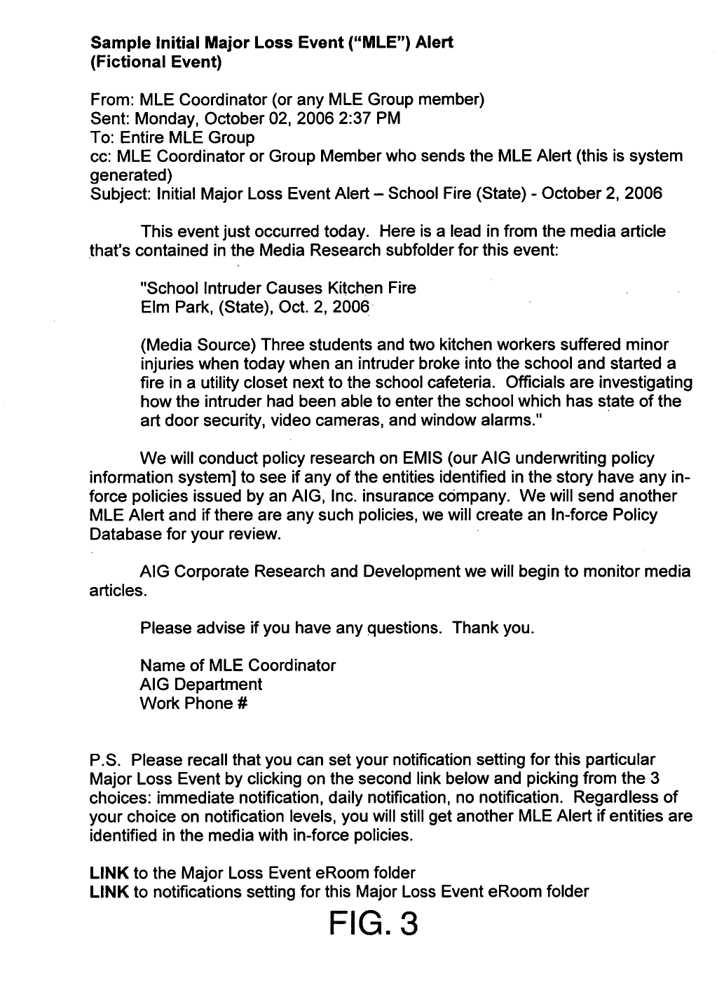

The MLE Initial alert can be stored in the event file. If an MLE coordinator sends out the MLE Initial Alert, he or she can create an event file on the MLE ECS for that MLE and send the alert from that event file. The body of the alert can contain a link so the user can access the MLE folder directly from the email. If another member of the MLE group sends out the MLE Initial alert, then the designated MLE coordinator can create the event file for that MLE in the ECS after the MLE Initial alert is sent and received. Referring to FIG. 3, a specimen of an MLE Initial alert is shown.

Referring to FIG. 2, the MLE Initial alert can initiate the initial net loss projection process. Information regarding the MLE can be collected to identify entities that were involved in the MLE (step 44). One effective source of information concerning the MLE is media coverage. In particular, news reports regarding the MLE can be carefully reviewed to identify the entities involved in, or impacted by, the MLE. The task of reviewing media coverage to collect facts surrounding the MLE and to identify the entities involved in the MLE is preferably performed by specially trained and experienced searchers. In some implementations, this task can be performed primarily by personnel of a Corporate Research & Development Information Center or a media branch of the company. The MLE group members can provide the media reviewers with input as to the type of information to collect. MLE group members can also gather information to supplement facts gleaned from analyzing news reports and other media coverage.

The news articles containing relevant information as to the identity of one or more entities involved in the MLE can be scanned or otherwise placed in an electronic format. The electronic files of news articles can be stored in a Media Research folder in the Event file for the MLE so that they can be accessed and reviewed by other users participating in the initial net loss projection operation. Selected portions of the news articles can be highlighted so that other users can readily understand why those entities are considered relevant to the MLE. Any member can add a media article to the Media Research folder by selecting an “add file” button and, for example, browsing for the article previously saved on the member's local drive.

Once an entity is identified as being involved in, or affected by, the major loss event (step 44), a member of the initial net loss projection team can determine whether the identified entity is insured by the insurance company (step 46). To that end, a member of the team can search through the database 38 of insurance policies (FIG. 1) to determine whether any of the potentially involved entities have an insurance policy from the insurance company and, if so, whether that policy is in force as of the event date. An In-force Policies folder can be provided in the event file to store search results information regarding the in-force policies of any of the identified entities. Information about the identified in-force policies can be placed in an MLE Policy Database that is provided in the Event file for the major loss event.

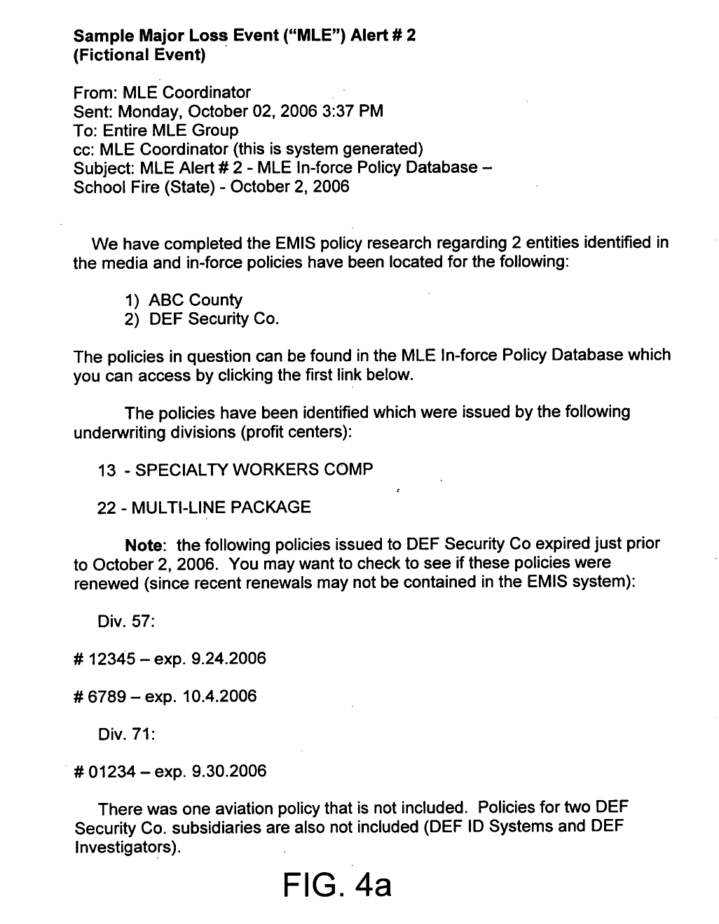

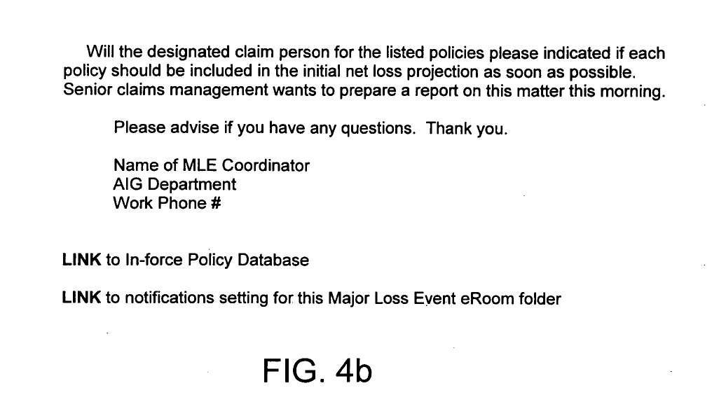

After the in-force policy information is found and stored in the MLE Policy Database, another MLE alert, a Policy alert, can be sent by the MLE coordinator to the members of the MLE group to inform them that policy information is available for review (step 48). The Policy alert can be saved in the Alerts folder in the event file by the MLE coordinator for future reference. Referring to FIG. 4, a specimen of a Policy alert is shown.

Referring to FIG. 2, after receiving the Policy alert, the group members can access the ECS to review the information in the MLE Policy Database to identify in-force policies for inclusion in the initial net loss projection (step 50). Selected members of the team can review the policy information to determine whether the particular policy is relevant to the incident. In one implementation, the contact persons in the Claims, Reinsurance, and Underwriting divisions review the information contained in the MLE Policy database, other underwriting systems, or the actual policies issued by their respective divisions to determine whether the policies should be included in the initial net loss projection.

Their decisions as to whether a policy is included in the initial net loss projection can be indicated by the designated MLE claims contact or back-up in the MLE Policy database that resides in the Event file. For instance, in one embodiment, the list of policies in the MLE Policy database includes an edit field for a reviewer to indicate whether a policy is to be included in the initial net loss projection by choosing one of Y, N, or TBD (“to be determined”) status options.

For each policy that is to be included in the initial net loss projection, the respective contact persons in the Claims, Reinsurance, and Underwriting departments of the division responsible for the policies also can retrieve the policies, endorsements, and reinsurance layoff sheets from the underwriting department as required and store electronic copies of the relevant policy or reinsurance documents in the MLE Policy database located in the event file (step 52). Any documents that are stored in this fashion are readily available to other members of the MLE group to facilitate further review and confirmation of the decision to include a particular policy in the initial net loss projection calculation.

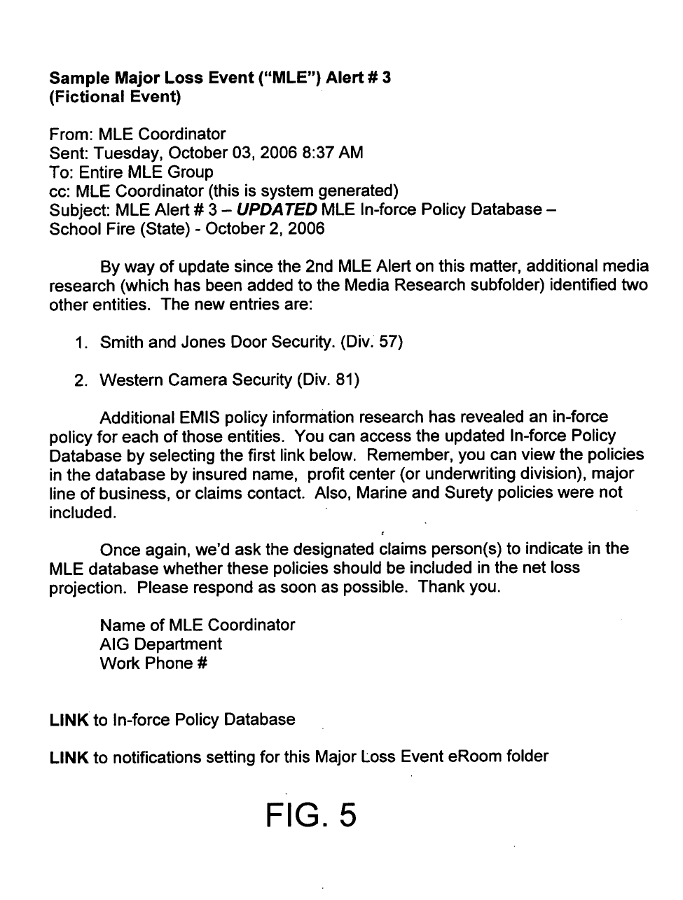

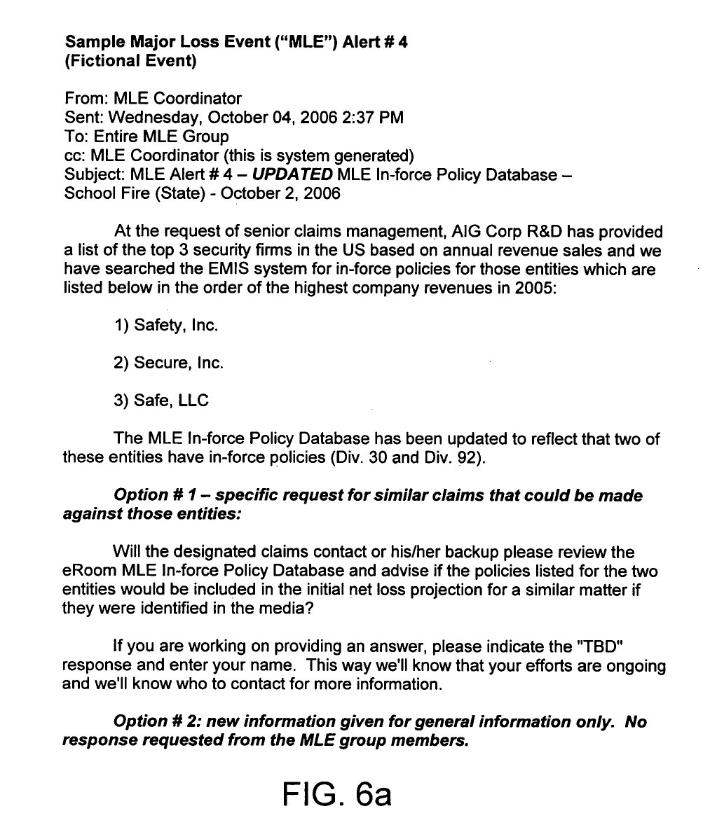

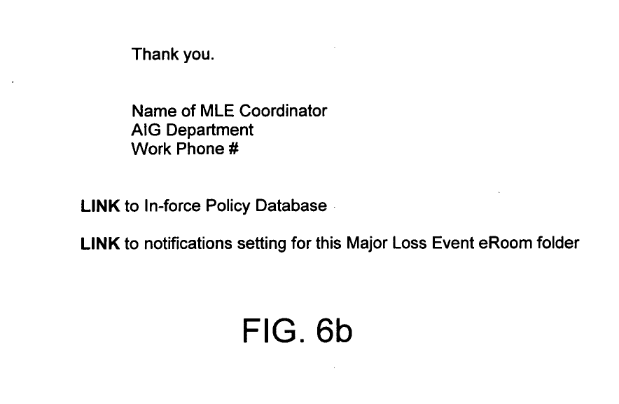

Throughout the initial net loss projection process, the collection of information to identify parties involved in the MLE (step 44) can continue to further refine the initial net loss projection. If an additional entity involved in the MLE is identified through the collection of additional information, searching (step 46) can be done to determine whether the recently-identified entity has an in-force policy from the insurance company as described above. If so, an updated alert can be sent to the initial net loss projection team to notify the members of the loss projection team that another entity with a policy from the insurance company has been identified (step 48). The alert can include an instruction to the designated members to perform the policy review analysis on the policy or policies of the additional entity, which they can carry out (steps 50, 52). Referring to FIGS. 5 and 6, specimens of an Updated Policy alert are shown.

Referring back to FIG. 2, the steps of the initial net loss projection method can continue to be performed until such time as senior claims management decides to terminate the process because, for example, all of the entities involved in the MLE have been ascertained and researched, the likelihood of identifying new entities involved in, or affected by, the MLE is low, and/or based on the amount of time elapsed since the occurrence of the MLE (e.g., seventy-two hours). Once the relevant in-force policies for the entities identified as being involved in the MLE are determined, the initial net loss projection can be made based on the insurance coverage limits of the policies (step 54) taking into account any applicable aggregate policy limits, policy deductibles, self-insured retention (“SIR”) amounts, and reinsurance.

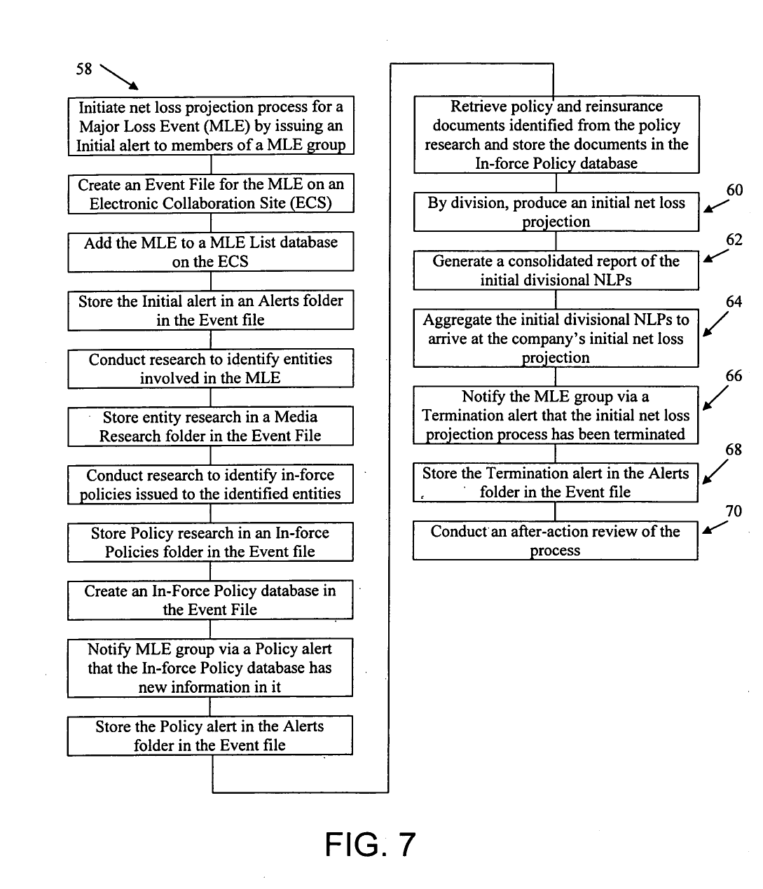

Referring to FIG. 7, another implementation of a method 58 for generating an initial net loss projection resulting from an MLE according to the present invention is shown. In this embodiment, the contact person for each division can aggregate the dollar limits of the relevant policies issued by that division to calculate the initial projected net loss exposure of that division resulting from the major loss event (step 60). The initial net loss projections amounts can be entered into the MLE Policy database for the particular event by the designated claim contact or his/her backup. The MLE Policy database can include a table that is in a spreadsheet form to facilitate number processing to generate a consolidated report of the initial net loss projections of all the divisions (step 62). The divisional initial net loss projections can be combined to provide an initial net loss projection for the entire insurance company (step 64). The total initial net loss projection is preferably presented in a report format that is easy to read and understand by the intended report recipients, which for instance may include the Chief Claims Officer and other high-level managers and executives of the insurance company.

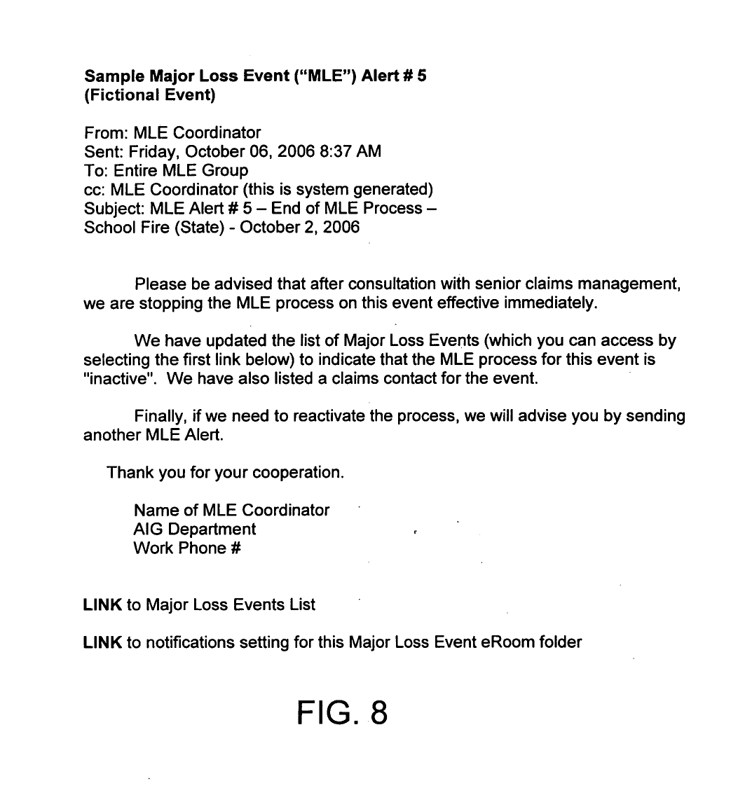

A Termination alert can be issued to members of the initial net loss projection team once the decision has been made to cease the performance of the process (step 66). Referring to FIG. 8, a specimen of a Termination alert is shown. Referring back to FIG. 2, the Termination alert can be stored in the Alerts folder in the event file (step 68). The MLE initial net loss projection team can conduct an after-action review of the performance of the process used to obtain the initial loss projection for the company (step 70) to determine whether any refinements to the process can be made. The other steps of the method 58 of FIG. 7 can be similar to those described above in connection with the method 39 of FIG. 2.

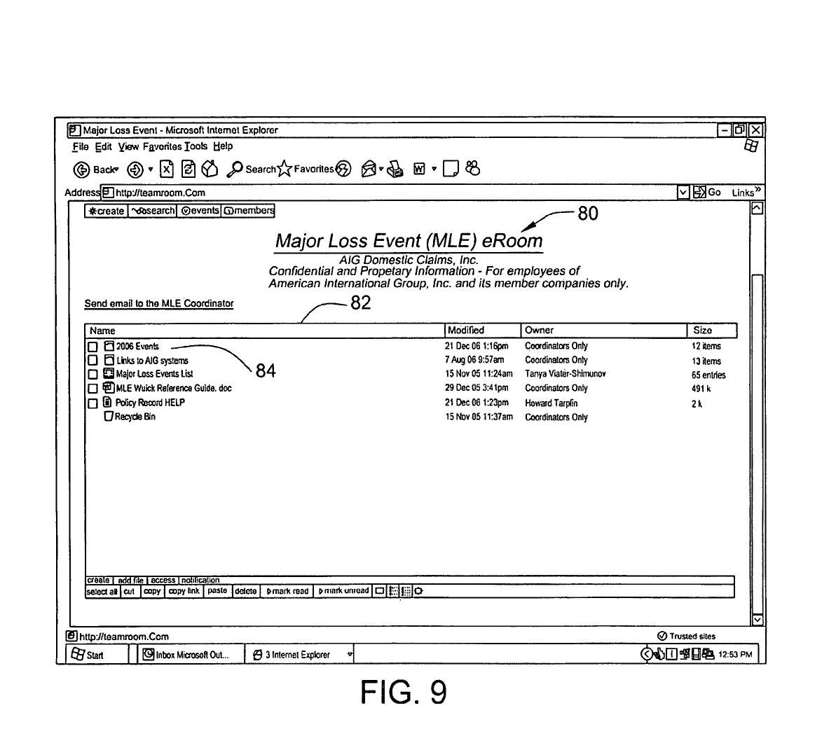

Information, data, and results of analysis can be placed in the repository 24 so that these components can be easily accessed and processed by users that participate in the initial net loss projection process. As mentioned above, in one embodiment, the repository is implemented as an ECS, which includes web pages designed to make it easy for a user to add, review, and edit information related to the initial net loss projection process. By way of example, FIGS. 9-15 show several user-interface web pages used in an embodiment of the system.

FIG. 9 shows a home page 80 of the ECS for initial net loss projections for major loss events. The Major Loss Event home page 80 can include a directory tree 82 to allow a user to quickly go to the page the user desires to view. One entry 84 in the directory 82 is the link to individual major loss event files. In this embodiment, the link 84 is entitled, “2006 Events.” When the user clicks on that link 84, a list of major loss events for the calendar year of 2006 is presented. In other embodiments, the major loss events can be grouped differently, such as, by location of the MLE or by the initial net policy limit projection associated with the MLE (which, can be provided without the benefit of a complete claims investigation into liability and damages issues), for example. The user can select a link to a particular major loss event, which takes the user to a webpage for the selected event.

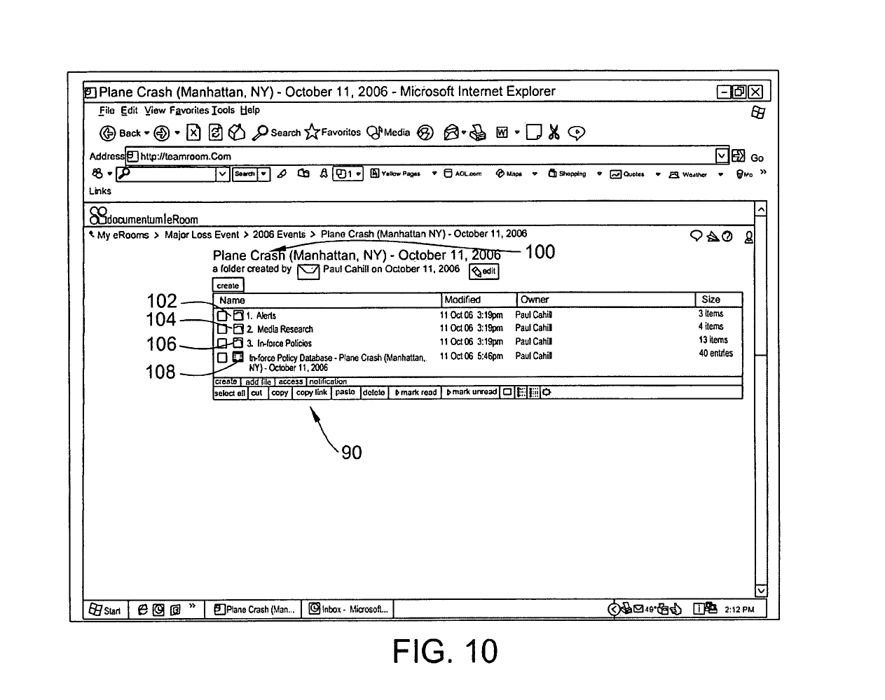

For example, FIG. 10 shows an Event webpage 90 in the ECS for a plane crash that occurred in Manhattan, N.Y., on Oct. 11, 2006. The Event webpage 90 can include a summary of the event, including information such as the date when and the location where the event occurred, a short narrative of the facts, and the status of the incident. The Event webpage 90 can include an Event file 100 for the MLE. The Event file 100 includes an Alerts folder 102, a Media Research folder 104, an In-Force Policies folder 106, and an In-Force Policy database 108. The folders 102, 104, 106 and the database 108 can be accessed via a graphical user interface operable via a mouse, for example.

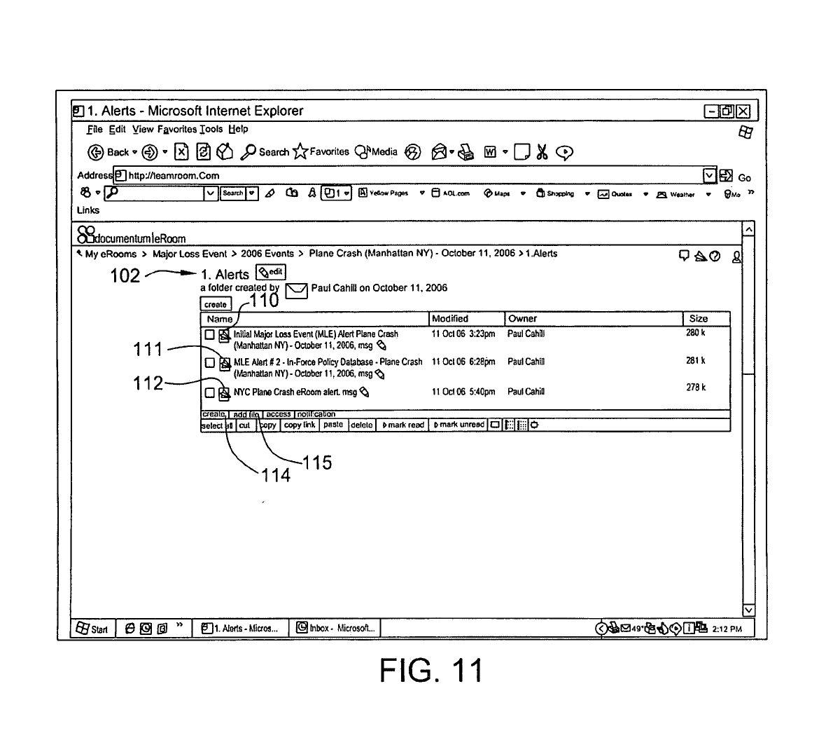

Referring to FIG. 11, the Alerts folder 102 can store the alerts 110, 111, 112 sent out at various stages of the initial net loss projection process. Additional alerts can be composed within the Alerts folder 102 by selecting a “create” button 114 and composing the alert message in a window opened for that purpose. Alternately, the alert can be composed outside of the Alerts folder 102 and added to the Alerts folder 102 by selecting an “add file” button 115. Selecting the add file button 115 triggers a prompt to browse the user's computer network for a file to add which can be accomplished via conventional means.

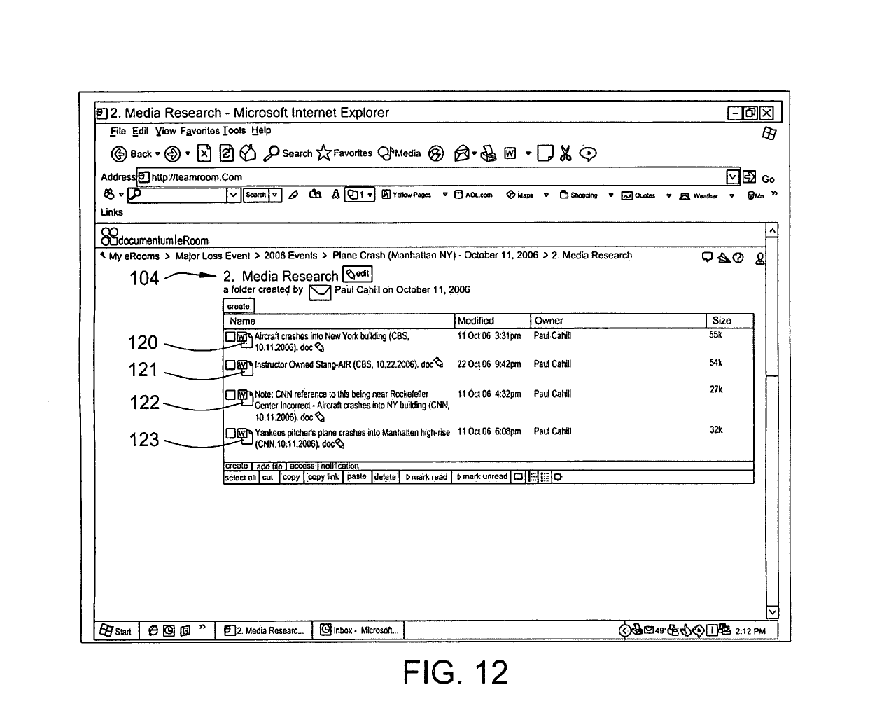

Referring to FIG. 12, the Media Research folder 104 can store information regarding the MLE gathered by research of the media coverage of the incident. As described earlier, this folder 104 can include highlighted copies of news reports. The Media Research folder 104 includes a set of collected media reports stored as electronic documents 120, 121, 122, 123. The Media Research folder 104 can include additional commentary and information supplied by those that have reviewed the stored documents 120, 121, 122, 123.

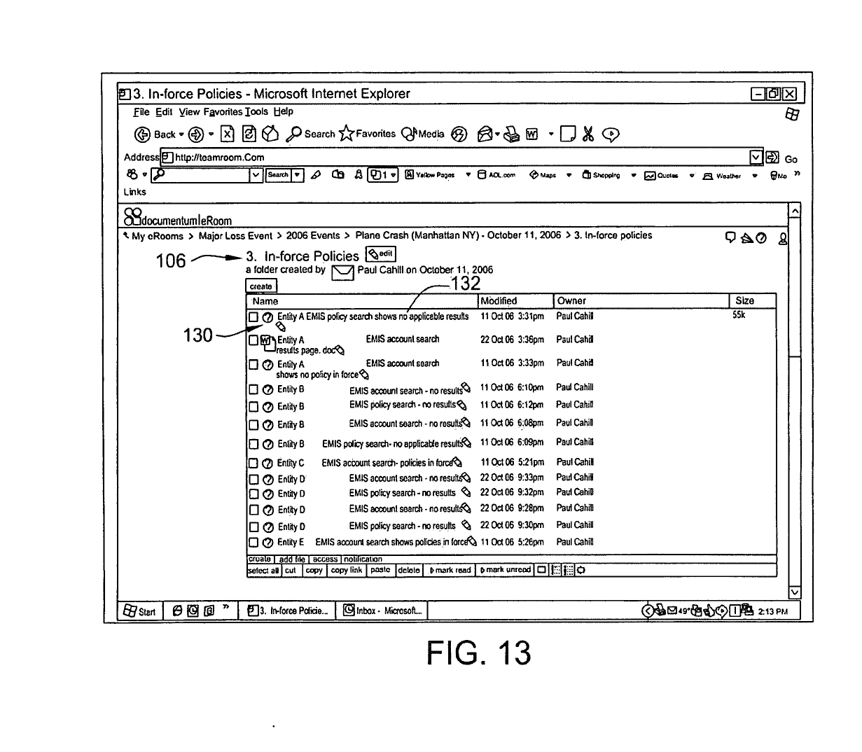

Referring to FIG. 13, the In-Force Policies folder 106 can store system information regarding all the in-force policies for the entities that have been identified as being involved in the MLE. A set 130 of electronic files of the results of the searches for in-force policies issued by the insurance company for each entity identified as being involved in the MLE can be stored in the In-Force Policies folder 106. The In-Force Policies folder 106 can display information 132 to allow the user to readily identify whether an entity has one or more policies in force that may be relevant to the net loss projection.

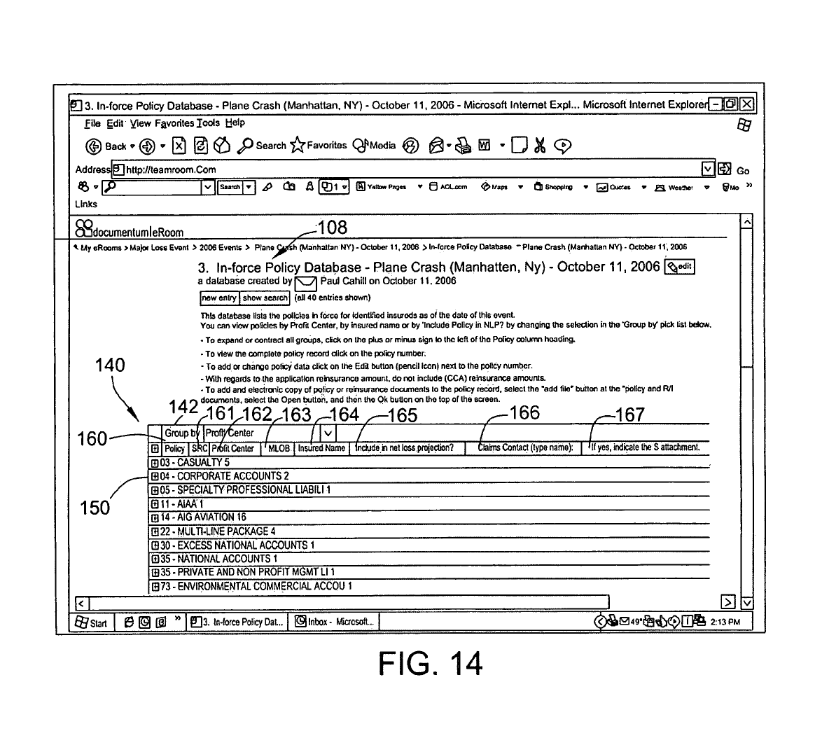

Referring to FIG. 14, when the user selects the MLE Policy database 108 in the Event file, the loss projection server 22 presents a webpage 140 for the in-force policies. The MLE Policy database 108 can include a table 142 that lists the in-force policies of the entities identified in the media by division of the insurance company. For example, a database entry 150 is provided for the Corporate Accounts underwriting division of the insurance company. The database entry 150 can indicate the number of policies of that division that are included in the MLE policy database 108. In this case, there are two insurance policies of the Corporate Accounts underwriting division. The Corporate Accounts database entry 150 can be expanded by selecting the “+” sign in its entry 150 to access a database entry for each policy contained therein.

For each policy, a database entry or record can include a plurality of fields 160, 161, 162, 163, 164, 165, 166, 167 that indicate the policy number, the source or major underwriting business area (e.g. domestic v. foreign), the underwriting division that underwrote the policy, the major line of business, the name of the insured, whether the policy should be included in the net loss projection, the claims contact, and, if the policy is to be added to the initial net loss projection, the net policy limit amount that should be added to the initial net loss projection. Each policy entry can be hyperlinked such that, when the user selects a policy, the server presents a page showing details of the policy, including, in some embodiments, copies of relevant documents for that policy.

The “Include in net loss projection?” field 165 can be filled in with a “Yes,” “No,” or “TBD” (To Be Determined). The policies with a “Yes” indication are included in the calculation of the initial projected net loss for the MLE. For the “Yes” policies, the claims contact person can enter additional policy information as an edit to the policy record such as the type of coverage, any applicable deductibles or self-insured retention amounts (“SIRs”), and the gross and net policy limit. The initial net loss projection amount can be updated when a newly identified in-force policy is added to the list or when the inclusion status of any in-force policy is revised.

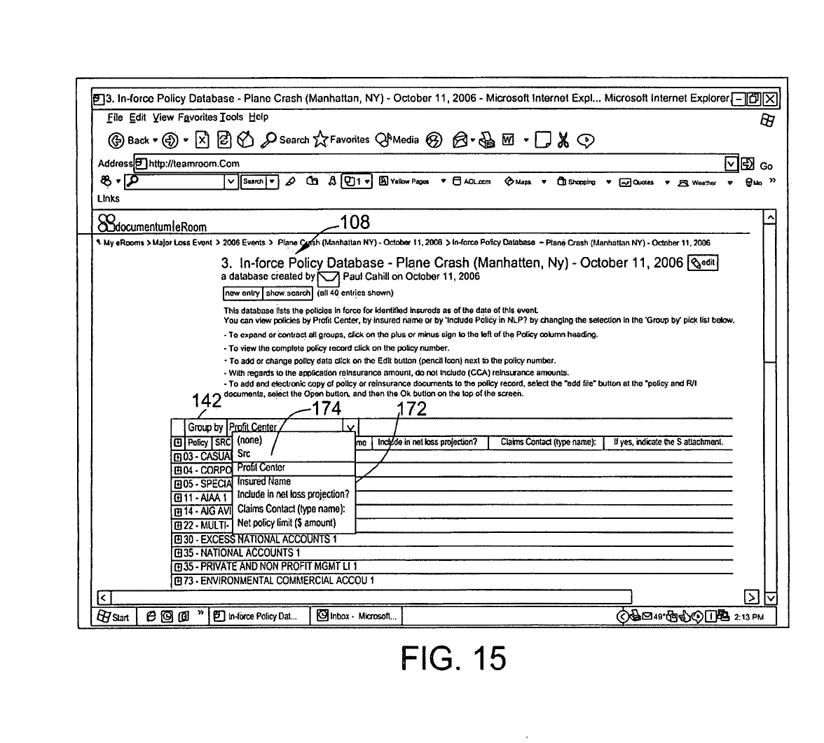

Referring to FIG. 15, the information in the In-force Policy database 108 can be organized by sorting by any one of the fields 160-167 by selecting the “Group by” button 170. A window 172 can be opened that includes a listing 174 of the fields. One of the fields can be selected from the listing 174, and the information in the table will be sorted by that field.

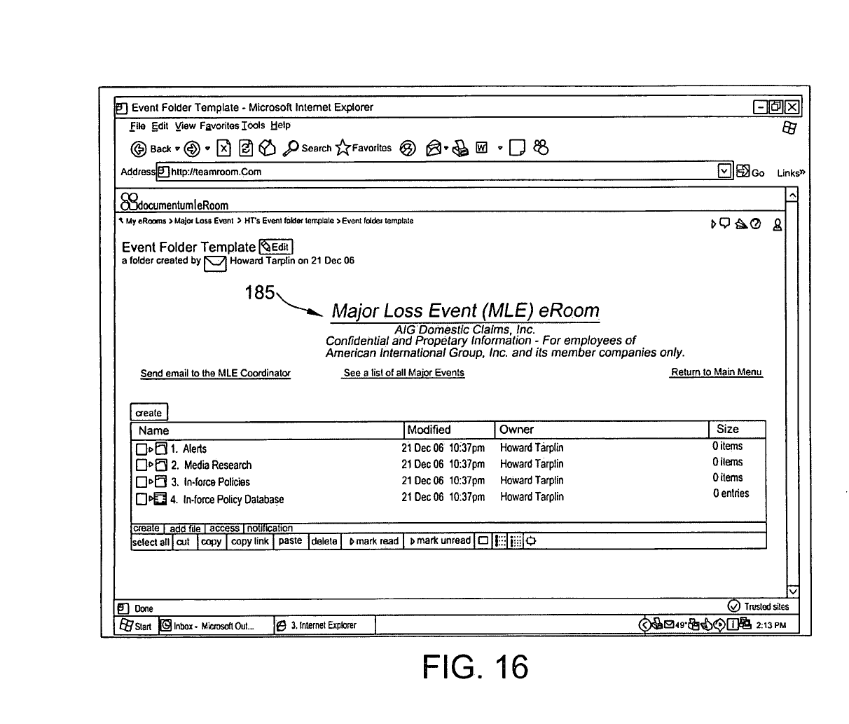

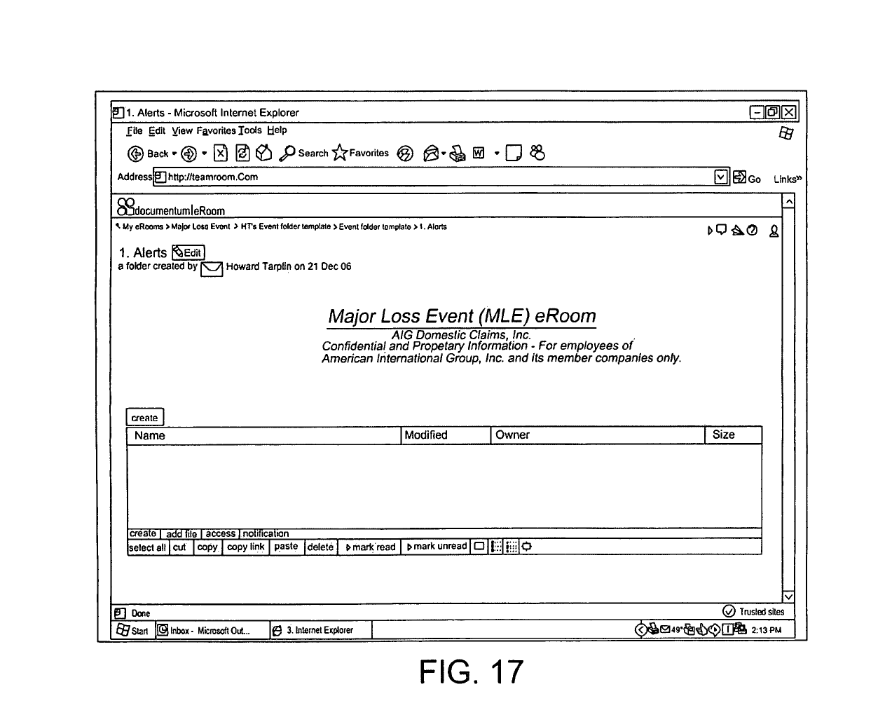

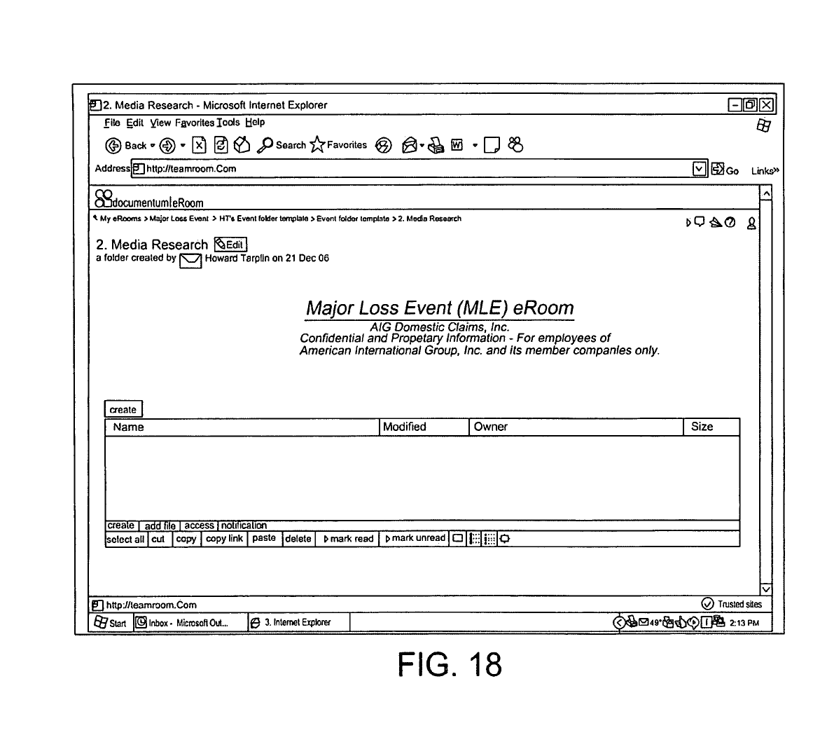

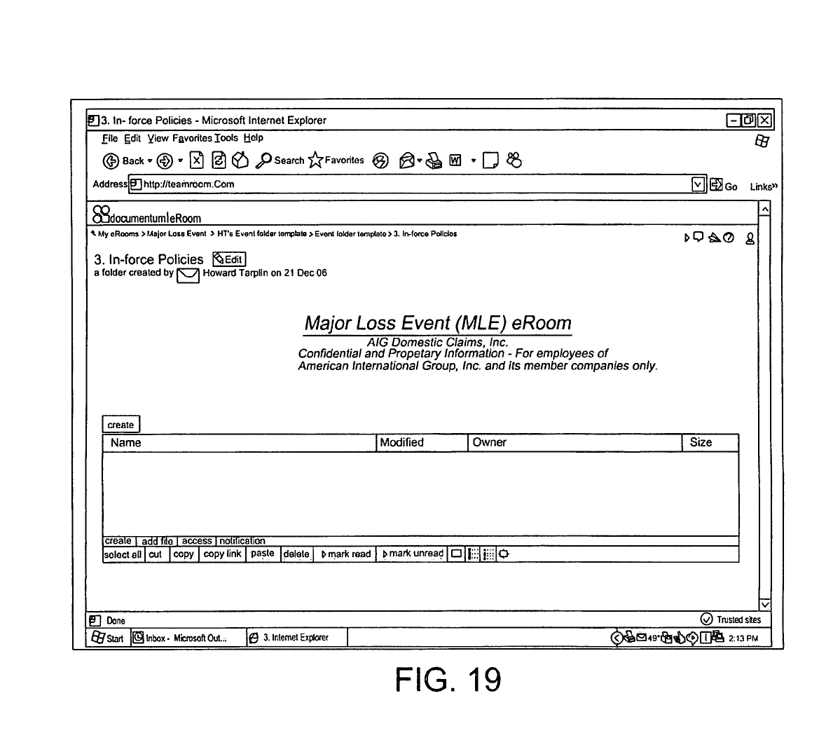

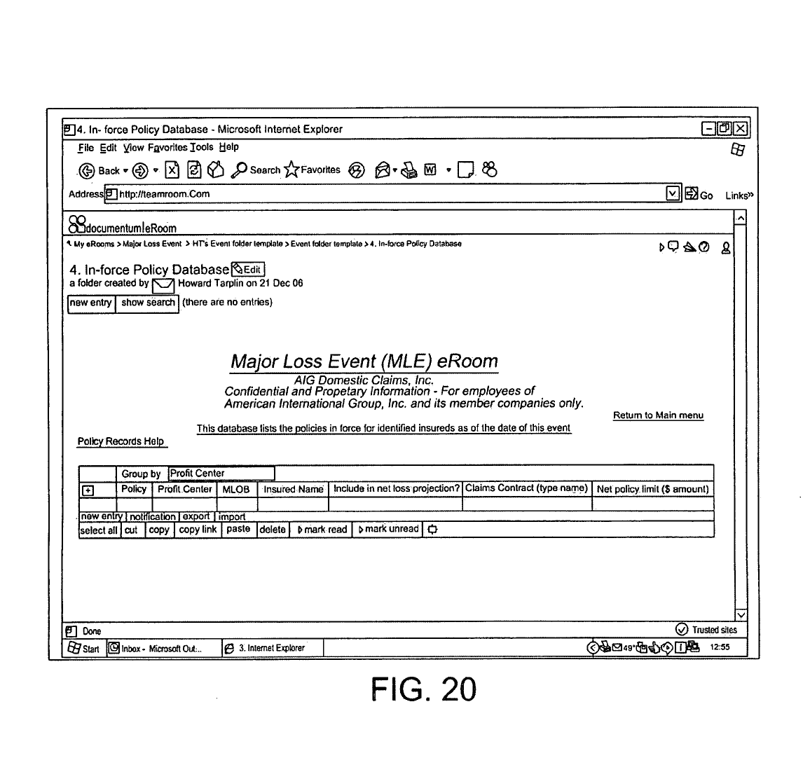

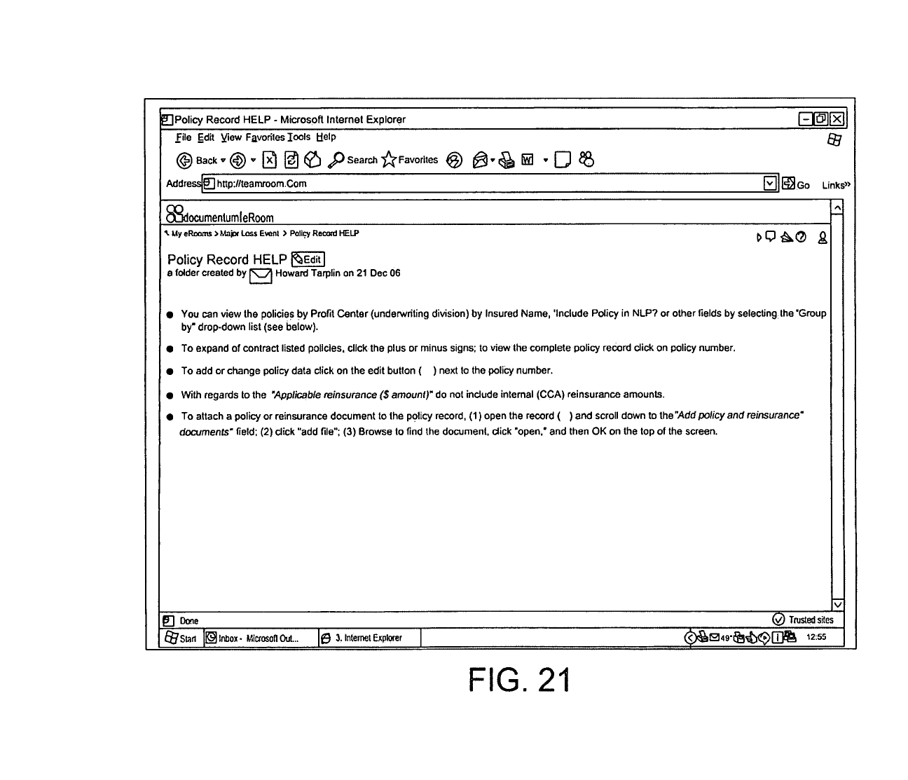

Referring to FIGS. 16-21, another embodiment of an event file 185 suitable for use with the present invention is shown. The event file 185 is in the form of a template that can be used to create a plurality of similarly-structured event files for storage in the ECS. By using the event file template 185 to create the event file for any particular MLE, uniformity and efficiency can be promoted.

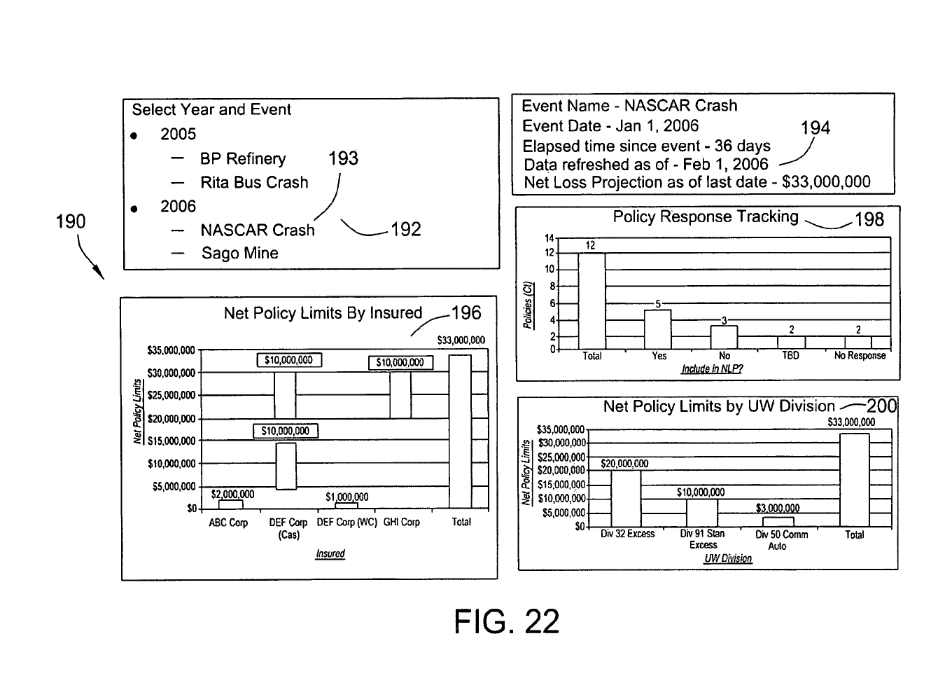

As mentioned earlier, the results of the MLE initial net loss projection are preferably presented in a way that is easy to understand. By way of example, FIG. 22 shows a dashboard webpage 190 that shows data pertaining to the initial net loss projection for a selected major loss event. The page 190 includes a sample list 192 of major loss events for which initial net loss projections have been made. The user may select from the list 192 an event of interest to see the initial net loss projection data for that event. In the example shown in FIG. 22, the user has selected to see the initial net loss projection for a fictional NASCAR crash event 193 that occurred in January 2006. A summary panel 194 shows that the net loss projection for that fictional event is $33 million. The prototype dashboard page also includes various charts to show how the initial net loss projection figure is derived. The visual presentation of the data assists the senior claims management quickly complete the cognitive tasks as hand—determining what the initial total net policy limit projection is, what insureds are involved, whether the policies are primary or excess, and what underwriting divisions or profit centers issued the policies included in the initial net loss projection. A Net Policy Limits by Insured chart 196 shows the net policy limits of the insurance policies for the entities identified in the media research. A Policy Response Tracking chart 198 shows the total number of in-force policies and the status of responses indicating their inclusion status, which may be Yes, No, TBD, or No Response. A Net Policy Limits By UW (underwriting) Division Chart 200 shows the sub-sums of net policy limits for the different underwriting divisions such as Excess, Starr Excess, Commercial Auto, etc., that underwrote the in-force policies included in the initial net loss projection.

The present invention provides an effective solution to the challenging task of putting together an initial net projection of loss in a very short period of time after the occurrence of a MLE. The unique collaborative process in accordance with the invention enables and encourages efficient collection and sharing of information required for initially projecting the maximum net loss exposure faced by the company in a timely, efficient and accurate manner. This is achieved by defining roles and responsibilities for the MLE process coordinators and other participants in various parts of the insurance company (e.g., Claims, Underwriting, and Reinsurance divisions) so that they can work together in an organized way to determine the initial net loss projection. To ensure the robustness of the process, the roles and responsibilities can be documented, and the primary and backup decision makers can be defined. The centralized coordination feature can be built into the MLE process and would not require ad hoc assignments for specific tasks each time an MLE occurs. This enables increased collaboration among the various branches/divisions of the company. The steps of the process can be well-defined and standardized so that the process can be used for different types of incidents. The information required for different stages of the process can be defined and standardized, and the process metrics can be identified and tracked. Responses made by the participants in the initial net loss projection process can be tracked and logged. By coordinating the efforts of the participants, the process and system of the invention can reduce or eliminate redundancies in information collection and decision making. It also can reduce the dependency of the process on single individuals.

The inventive process is comprehensiveness in that it can be used to gather and share information from a company-wide perspective. By designating participants in all the relevant branches of the insurance company, all in-force policies issued by the company can be included in the initial net loss projection analysis. The creation of the common repository 24 allows the insurance and reinsurance information to be securely stored while accessible to multiple distributed users. The information collected and decisions made throughout the process can be reviewed during the process to ensure their accuracy and completeness. Moreover, logging or archiving the information and decisions enables reviews to be made after the initial net loss projection process is completed for purposes of providing continuous system and process improvements.

### EXAMPLE

When five miners were killed in an explosion at a coal mine in eastern Kentucky on May 20, 2006, the MLE process was initiated by an MLE coordinator who sent out an Initial MLE Alert to the entire initial net loss projection group. The company's research and development area began to conduct media research to identify the entities involved in the ownership and operation of the mine. Additionally, media articles identified the manufacturer of air tanks that were part of the safety equipment at the mine. Those articles were placed in the Media Research folder in the event file created for that event on the MLE ECS site. All MLE members received an automatic notification that the articles were placed in the site. The MLE coordinators then conducted research to see if there were any in-force policies issued to the identified entities. When policies were located, an MLE In-force Policy Database (“MLE Policy Database”) of those policies was created in the event file. The MLE Policy Database contained information downloaded from the company's underwriting policy systems and uploaded into the ECS database. Another MLE alert was sent to notify the MLE group that the MLE Policy Database was available for their review. The designated claims, underwriting and reinsurance participants reviewed the list of policies. A designated claims contact indicated whether or not each policy should be included in the initial net loss projection by indicating the appropriate response in an edit field for the policy record located in the MLE Policy Database. The new process was successful in identifying insureds and policies which would have been missed using the previous method.

In view of the many possible embodiments to which the principles of this invention may be applied, it should be recognized that the embodiment described herein with respect to the drawing Figures is meant to be illustrative only and should not be taken as limiting the scope of invention. Those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof. By way of example, this invention may have applications to other areas of business such as banking. A significant financial event could impact different business areas of a bank such as retail lending, commercial lending, asset management and others. The different departments and operations may have different obligations and financial exposures arising from the single event. There will be a need to share information quickly with those areas regarding the event and seek input from the different areas regarding how, if at all, the event may involve those areas. A centralized ECS will allow this process to proceed quickly. Defined roles and responsibilities will allow for a coordinated and pre-planned process giving assurance to all levels of a financial institution that the major event process is underway and knowledgeable and trained participants are actively moving forward to accomplish the individual and overall corporate tasks. The process can be used to make an initial projection of the total net financial exposure faced by the bank as a result of the significant financial event.

1. A method for making an initial loss projection of an insurance company resulting from a major loss event, comprising:
providing a common information repository on a computer network accessible by a plurality of members of a loss projection team;
identifying entities involved in, or affected by, the event;
for each identified entity, identifying in-force policies of said identified entity issued by said insurance company;
presenting the in-force policies in an event file for the event at the common information repository;
identifying selected in-force policies to be included in the initial net loss projection from the in-force polices presented in the common information repository;
calculating, based on the selected in-force policies, an initial projected net loss for the event.

2. The method according to claim 1, further comprising the steps of:
determining whether said event requires an initial net loss projection; and
sending an event alert to members of the initial net loss projection team regarding the event.

3. The method according to claim 2, further comprising the step of:
creating the event file for the event in the common information repository upon receiving the event alert.

4. The method according to claim 2, wherein the initial net loss projection team comprises a coordinator, the method further comprising the step of:
creating, by the coordinator, the event file for the event in the common information repository either upon receiving information about the major loss event or upon receiving the event alert sent out by another member of the initial net loss projection team.

5. The method according to claim 3, further comprising the step of:
storing the event alert in the event file.

6. The method according to claim 1, wherein the step of identifying entities involved in, or affected by, the event includes reviewing media reports.

7. The method according to claim 6, further comprising the step of:
storing copies of the reviewed media reports in the event file.

8. The method according to claim 1, wherein the step of identifying selected in-force policies includes providing markings in the event file to indicate whether the in-force policies presented in the common information repository are to be included in the initial net loss projection.

9. The method according to claim 1, further comprising the step of:
generating a report indicating the initial projected net loss for the event.

10. The method according to claim 10, wherein the report includes a chart for showing components of the initial projected net loss.

11. The method according to claim 1, wherein the in-force policies include insurance policies and reinsurance information.

12. A system for performing an initial loss projection for an event, comprising:
a computer network connecting members of an initial net loss projection team; and
a server residing on the computer network and accessible by the loss projection team over the computer network, the server being programmed to host a common information repository for the event, the common information repository having an event file for storing information identifying entities involved in, or affected by, the event, in-force policies of the entities, and identification of selected in-force policies of the entities that are to be included in the initial net loss projection.

13. The system according to claim 12, wherein the event file further includes an initial net projected loss calculated based on the selected in-force policies.

14. The system according to claim 13, wherein the initial net projected loss is presented in a report in the event file.

15. The system according to claim 14, wherein the report includes a chart for showing components of the initial net projected loss.

16. The system according to claim 12, wherein the event file includes a folder for storing alerts sent to members of the initial net loss projection team in connection with the initial net loss projection.

17. The system according to claim 12, wherein the information stored in the event file for identifying the entities includes copies of media reports regarding the event that have been reviewed for collecting information on the entities.

18. The system according to claim 12, wherein the in-force policies include insurance policies and reinsurance information.
